(19) United States
(12) Patent Application Publication
(10) Pub. No.: US 2003/0069915 A1
(43) Pub. Date: Apr. 10, 2003

(54) Method for authenticating mobile printer users

(76) Inventors: James Clough, Meridian, ID (US); Darrel Cherry, Meridian, ID (US)

Correspondence Address: HEWLETT PACKARD COMPANY, Intellectual Property Administration, P.O. Box 272400, Fort Collins, CO, 80527-2400, US

(21) Appl. No.: 10/004,173

(22) Filed: Oct. 9, 2001

(51) Int. Cl. G06F 9/00

(52) U.S. Cl. 709/100; 709/101

(57) ABSTRACT

In a hotel or short-term office environment, a guest is provided with a connection to a local area network (LAN). A printer, also attached to the LAN, allows the guest to make hard copies of documents. Using a browser, the guest is directed to a web site from which may be downloaded an authentication code to allow access to the printer, and a print driver and a port monitor to allow operation of the printer. Following installation of the downloaded software, any print job sent by the laptop to a print server associated with the printer includes the authentication code. Upon receipt of the authentication code, the print server authenticates the print job, and sends it to the printer located within the hotel room.

### TECHNICAL FIELD

This disclosure relates to a system and method for authenticating the print jobs sent to printers typically available for use over short periods of time, particularly in a business travel setting.

### BACKGROUND

It is frequently the case that business travelers carry with them a laptop computer. Such computers have most if not all of the functionality of desktop computers and weigh much less. As a result, many travelers simply cannot be without them.

However, portable printers are not nearly so developed, and few people travel with a printer. As a result, many hotels provide printers within selected rooms for use by guests accompanied by their own laptop computers. The intent is to provide the guest with many of the capabilities of their office within a hotel room.

Unfortunately, it is frequently the case that a printer in a hotel room is actually useless to many guests, since the installation of the appropriate print drivers is too time-consuming or too difficult for many computer users. As a result, many computer users feel that they must do without a printer when traveling, and many hotels are unable to provide for the needs of their guests.

Additional problems are present in most hotel printing environments. Methods for charging hotel guests for the use of Internet connections and printer use are flawed, because of inadequate association between the guest, the guest's room and the use of the printer within that room. Failure to associate the user with the printer can also result in print jobs being sent to printers in the wrong room. Similarly, the bill for the print job may be sent to the wrong room. In some cases, where third parties know the address of the printer, spam-type commercial advertisements can be printed out. This may result in a guest receiving a bill for the printing and may result in the hotel losing the goodwill of the guest.

### SUMMARY

An implementation of a system and method for authenticating printer users includes downloading and installing a print driver and an authentication code on a workstation. When the workstation sends a print job to the print server, the print server determines if the authentication code is valid, thereby verifying the print job. Where the authentication code is valid, the print server spools the job to a printer.

### BRIEF DESCRIPTION OF THE DRAWINGS

The same numbers are used throughout the drawings to reference like features and components.

FIG. 1 illustrates a hotel having an exemplary room equipped with a LAN connection and a printer.

FIG. 2 illustrates a web page-based user interface to facilitate the downloading of software to a laptop computer.

FIG. 3 illustrates the software components downloaded to a laptop computer, thereby forming a print system whereby the guest has access to the printer provided.

FIG. 4 illustrates a print system wherein a workstation sending a print job is not located, or appears to not be located due to the use of a VPN connection, within a hotel room in which the printer to which the print job will be spooled is located.

FIG. 5 is a flow diagram illustrating a method by which a hotel guest obtains an authentication code and required print driver software, and successfully sends print jobs to a printer located within a hotel room.

### DETAILED DESCRIPTION

In a hotel, short-term office or similar transient environment, a guest is provided with a connection to a local area network (LAN), which in many cases provides Internet access. A printer, also attached to the LAN, is provided to allow the guest to make hard copies of documents. Upon establishing a connection with the LAN, the guest visits an Internet site or similar portal from which software may be downloaded. In one implementation, the software to be downloaded includes an authentication code, a print driver and a port monitor. An installation wizard may be provided to facilitate the installation. Following installation, any print job sent by the laptop to the print server includes the authentication code. Upon verification of the authentication code, the print server sends the print job to the printer located within the hotel room. On concluding the stay within the transient environment, the guest de-installs the authentication code, the print driver and port monitor. At checkout, or in response to the passage of time, the authentication code is expired.

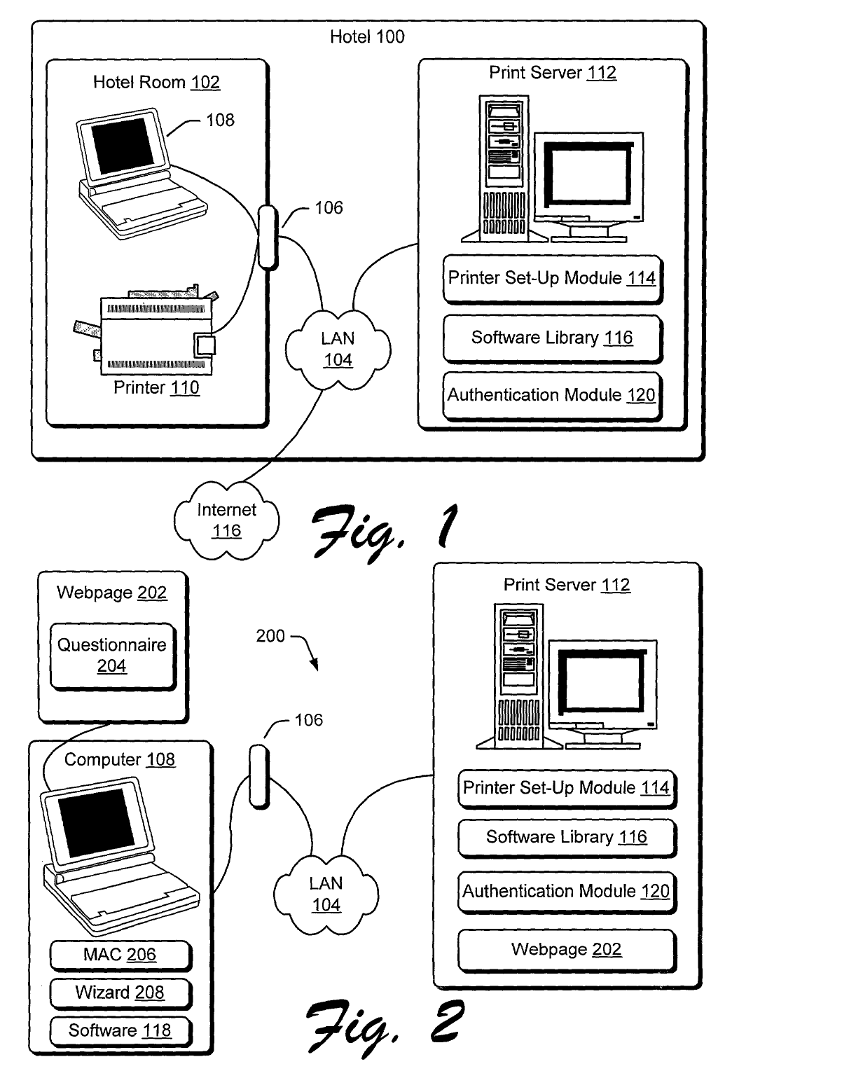

FIG. 1 shows an exemplary facility such as a hotel 100, short-term “office park,” Internet cafe or similar short-term or transient-use environment wherein computer users may need to use a printer for a limited period of time. A plurality of hotel rooms 102, short-stay offices or similar locations are connected by an internal LAN 104 or similar network. The LAN may utilize Ethernet, telephone wiring or other network technology. A compound network may be employed; for example, a multiple topology network may support Ethernet, telephone wiring and/or other network technology. Each hotel room provides a connector 106 to which connection to the LAN may be made. The connector is appropriate to the type of network technology employed, and typically provides a plurality of receptacles to support a plurality of devices. Accordingly, guests having a workstation such as a laptop computer 108 adapted to use one of a variety of network and/or modem connections are accommodated.

In a typical implementation of the short-term environment, a printer 110 is provided by the management. The printer is connected through the connector 106 to the LAN 104, through which the printer communicates with a print server 112.

The print server 112 includes a printer set-up module 114, which manages the transmission of print drivers and port monitors to the guest's laptop 108. The printer set-up module includes a library 116 containing a number of print drivers and port monitors suited for installation on a number of commercially known computers in combination with known operating systems and software applications. An authentication module 120 supplies an authentication code to the guest's computer 108 during software installation on the laptop. Additionally, in the course of processing each print job, the authentication module on the print server reviews the print job to verify the validity of the authentication code sent by the guest's computer with the print job.

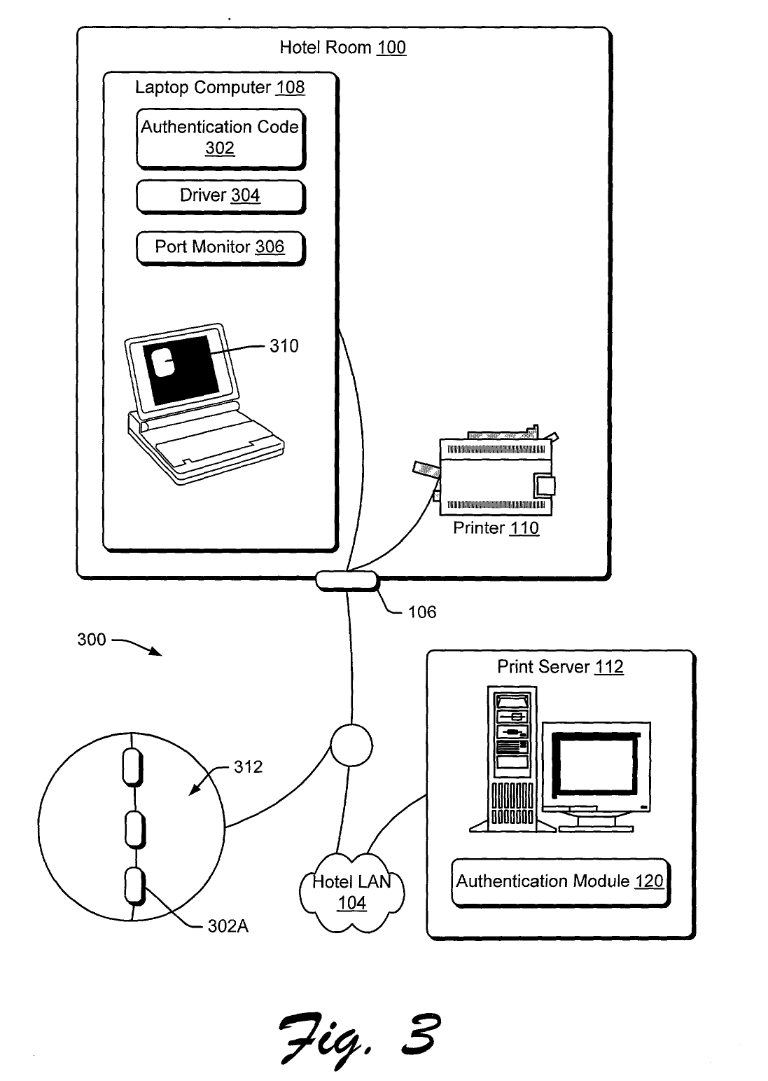

FIG. 2 shows an implementation of a software installation system 200 that configures the guest's computer to be able to send print jobs to the printer 110 provided by the hotel or other facility. To determine what software should be installed, the printer set-up module 114 of the server 112 obtains information about the guest's computer 108. The information allows selection of an appropriate print driver and port monitor for installation on the guest's computer.

In the implementation of the software installation system 200 seen in FIG. 2, a webpage 202 is based on the print server 112 and may be viewed on the workstation 108. The webpage uses an http- or https-based user interface to facilitate obtaining information from, and download software to, the computer 108. The guest's web browser is directed to the web page 202 in an automatic fashion, or in response to the guest following verbal or written instructions provided by the hotel management.

Upon visiting the website 202, the guest is presented with a questionnaire 204 allowing entry of information related to the guest's computer 108. Alternatively, fields within the data requests sent by the guest's browser allow determination of the relevant software and hardware configuration of the guest's computer. Additionally, the MAC (media access control) address 206 of the laptop 108 is obtained at set-up, so that verification that the laptop is within the hotel, hotel room or other authorized location at print time may be made, if desired. The MAC is visible to the print server 112, even when the laptop 108 uses a VPN connection. In many commercial applications, the guest will be asked to authorize payment for Internet access and for the operation of the printer 110.

Upon determination of the hardware and/or software configuration of the guest's computer 108, the printer set-up module 114 selects from the library 116 an appropriate print driver and port monitor for installation on the guest's computer. This software 118 is then transferred to the guest's computer. The authentication module 120 on the print server supplies an authentication code to the guest's computer and records the authentication code within a data structure on the print server. In one implementation, the authentication code is transmitted over a secure protocol, such as https.

The printer set-up module 114 may provide a wizard 208 or similar install program, to aid the guest to complete the process of installing the software, which in one implementation includes a print driver and port monitor. Additionally, the wizard could be configured to aid in the removal of the installed software, and the reinstallation of the guest's original print driver and port monitor.

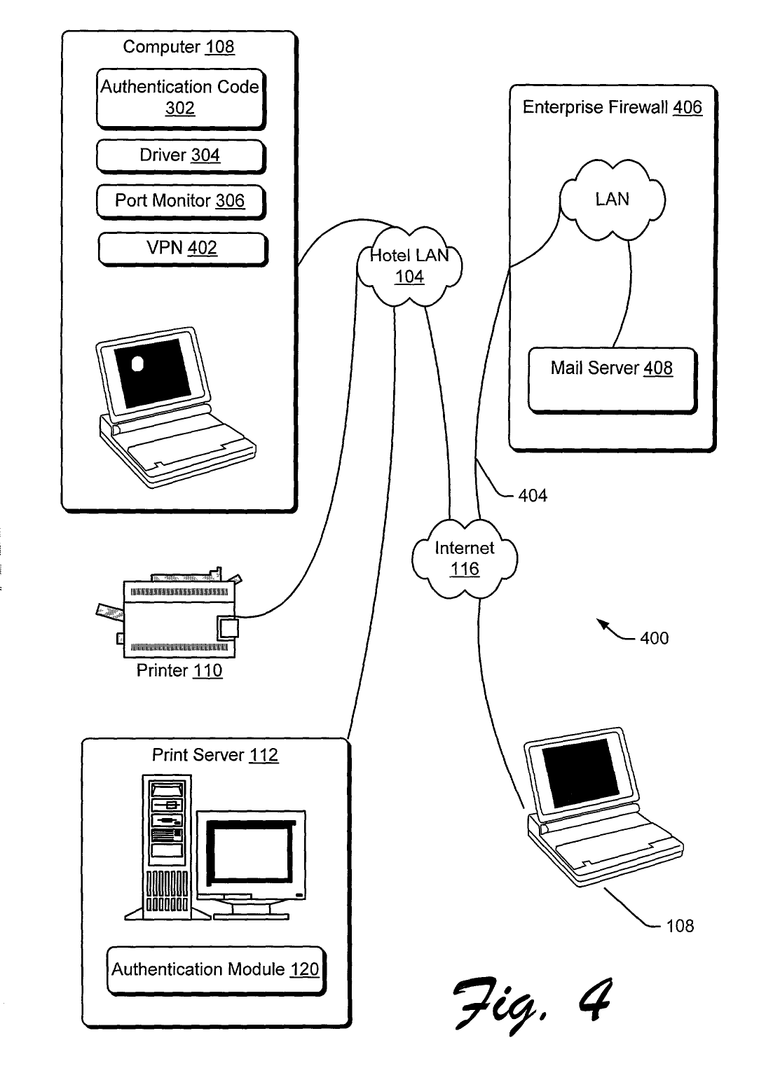

FIG. 3 shows an implementation of a printing system 300, wherein software supplied by the print server 112 has been installed on the guest's computer 108, thereby enabling the guest to send print jobs to the printer 110 supplied to the guest.

In the implementation of the printing system seen in FIG. 3, the wizard has installed software and data on the guest's computer 108, including an authentication code 302, a print driver 304, and a port monitor 306. The print driver and port monitor are software modules selected from the library 116 by the printer set-up module 114. The authentication code 302 installed on the guest's computer is a unique code that accompanies each print job sent by the guest's computer to the print server 112.

In most cases, the guest prints from within an application using the print command under the file menu, or equivalent shortcut commands. Alternatively, an icon 310 and associated software may be installed on the desktop of the guest's computer. The icon allows the guest to drag and drop document files to be printed, thereby facilitating printing without the need to open an application.

A print job 312, illustrated in the course of travel between the laptop 108 and the print server 112, is in the form of a plurality of data packets. One data packet includes a copy 302A of the authentication code 302. Other data packets include device ready bits produced by the print driver 304. In one implementation, the print job is sent over an https connection, to provide security for the print data. The use of http, https or other protocol is transparent to the user, who is merely initiating the print job, and is typically unconcerned as to the protocol used.

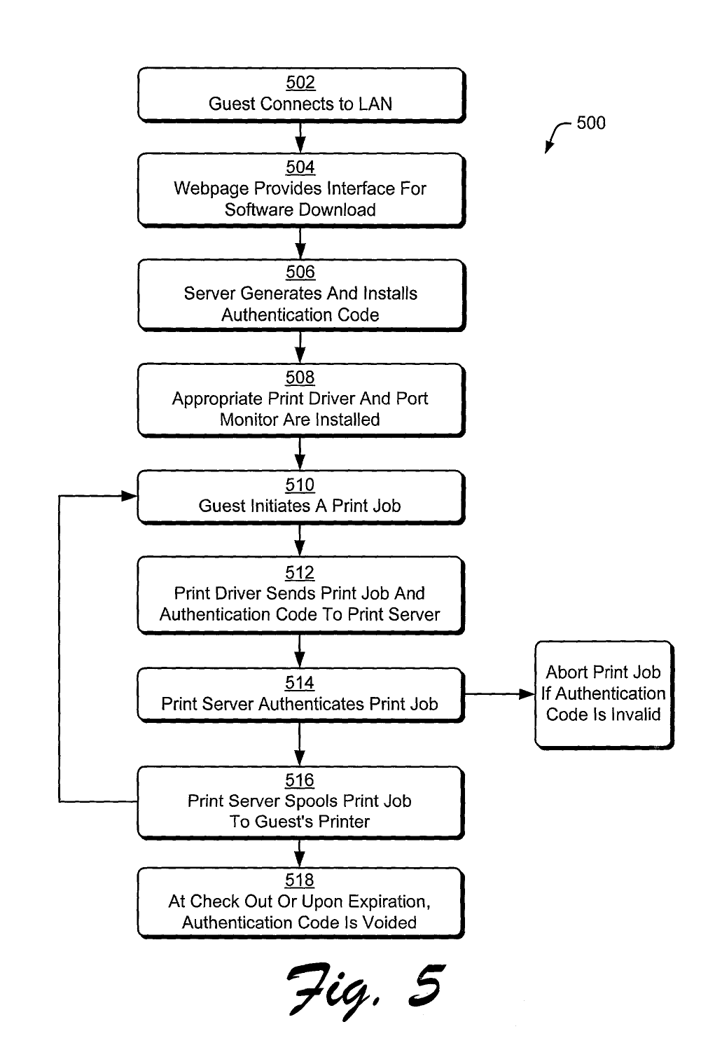

FIG. 4 shows a printing system 400 similar to that of FIG. 3; however, the guest's computer 108 has utilized VPN (virtual private network) software 402 to open a VPN connection 404 to pass through an enterprise firewall 406. This is common practice; for example, the guest may desire to access a mail server 408 operated by the guest's employer behind the firewall. The guest may want to make a hard copy of an email message downloaded in this manner; accordingly, the guest may initiate a print command. Due to the use of the VPN connection, the print job initiated will appear to the print server 112 to have originated from a computer located within the firewall 404. However, the print job will contain a copy of the authentication code 302. As a result, the print server 112 will verify the authenticity of the print job, and send the print job to the printer 110.

The printing system 400 of FIG. 4 also allows the guest's computer 108A to be moved to a location beyond the confines of the hotel room assigned to the guest. Such a location could be at a hotel conference room, a client's site, or a similar off-site location. However, as seen above, the location from which the print job is sent is not important, provided the authentication code 302 is sent with the print job. Since the print driver 304 includes the authentication code with the print job, the guest's computer 108 may send print jobs to the printer 110 from any location by sending print jobs to the print server 112. Upon receipt of a print job by the print server 112, the authentication module 120 examines the authentication code 302 sent. Where the code is valid, the print job is spooled to the printer 110 located in the guest's room.

FIG. 5 is a flow diagram illustrating an exemplary method 500 by which the computer of a hotel guest may have software and data installed, including an authentication code 302, print driver 304 and port monitor 306. By sending a copy of the authentication code with any print job, an authentication module in the print server is able to verify the authenticity of the print job. Once authenticated, the print job is spooled to a printer located on a network within a hotel room, Internet cafe, short-term office park or similar transient location.

At block 502, the guest connects a laptop 108 or other computer to a LAN connector 106. By activating a browser program, the guest is able to access a web page 202 delivered from the print server 112 or other location. In many cases, the guest must signify agreement to pay a fee associated with use of the LAN, Internet connection and/or printer 110.

At block 504, the guest's computer obtains a webpage from the print server 112 or other location. In the course of obtaining the webpage, fields sent by the guest's browser associated with data requests convey, to the printer set-up module 114 of the print server, information about the guest's computer's operating system and hardware. Alternatively, the guest may convey this information by filling out a questionnaire 204. The questionnaire determines manually, or the fields within the browser's requests determines in an automated manner, the type of print driver and port monitor required by the guest's computer. The requirements of the guest's computer may vary, depending on the make, model and hardware included within the computer, the revision level of operating system already installed, and other factors.

At block 506, the authentication module 120 of the print server generates an authentication code 302, which is transferred to the guest's computer 108.

At block 508, the appropriate print software 118, typically including a print driver 304 and a port monitor 306, are transferred to the guest's computer. The print software may be installed on the guest's computer by the guest, or may be installed automatically by a wizard 208 transferred with the print software.

At block 510, the guest initiates a print job. In one example, the guest is working within an application, such as a word processor, on a document file, and initiates a print job using menu or keyboard commands. In another example, the guest uses a mouse to drag and drop a document file to be printed onto the icon 310, thereby initiating the printing process. In a further example, the guest uses a VPN connection to tunnel into a firewall at the guest's employer, to obtain the guest's email. The guest then initiates a print command to print the email. The print job has the appearance of having been initiated by a computer behind the firewall.

At block 512, the print driver 304 and port monitor 306 transmit the print job, together with the authentication code 302 and a MAC address 206, to the print server 112. The print job may be transmitted over an http, https or other connection.

At block 514, the print server receives the print job, processed by the print driver 304, from the workstation 108. The print job contains a copy of the authentication code 302. The authentication module 120 on the print server 112 reviews the authentication code to verify its validity, and therefore the validity of the print job. Where the authentication code is missing, expired or otherwise invalid, the print job is aborted. Optionally, the MAC address 206 may be examined, to verify that the laptop is present within the hotel 100, hotel room 102 or other required location.

At block 516, the print server spools the print job to the guest's printer 110. The guest may have a number of documents to print; accordingly, blocks 510 through 516 may be repeated.

At block 518, in one implementation, the validity of the guest's authentication code 302 expires at the end of the period during which the guest agreed to pay for printing services. Alternatively, the authentication code expires upon the guest's checkout from the hotel or office park.

In conclusion, by providing a guest's computer with an authentication code, a print driver and a port monitor, the guest is able to print over a network to a printer installed in the guest's hotel room, short-term office or other location. Because the authentication code is included with any print job sent to the print server, an authentication module within the print server may determine if the print job is legitimate and should be authenticated. Where the print job is valid, the print job is sent over the network to the printer in the guest's room. Accordingly, incorrect printing charges, incorrectly directed print jobs, spamming by advertisers to printers on a network and other undesired activity is prevented.

Although the disclosure has been described in language specific to structural features and/or methodological steps, it is to be understood that the appended claims are not limited to the specific features or steps described. Rather, the specific features and steps are exemplary forms of implementing this disclosure.

1. A print server, for processing a print job sent by a workstation, the print server comprising:
a printer set-up module to provide a print driver for installation on the workstation; and
an authentication module to supply an authentication code to the workstation, and to review the print job sent by the workstation to determine validity of a copy of the authentication code attached to the print job.

2. The print server of claim 1, additionally comprising:
a software library to contain the print driver and at least one additional print driver.

3. The print server of claim 1, additionally comprising:
a webpage interface to gather information from the workstation to indicate a preferred print driver to be sent to the workstation.

4. The print server of claim 1, additionally comprising:
a web page to present a questionnaire to a user of the workstation.

5. The print server of claim 1, additionally comprising:
a MAC address, transferred from the workstation to the print server, to aid in the authentication of the workstation.

6. A method of printing, comprising:
attaching a workstation to a LAN;
downloading and installing a print driver on the workstation;
downloading an authentication code to the workstation;
sending a print job, containing the authentication code, from the workstation to a print server;
verifying validity of the authentication code; and
sending the print job from the print server to a printer.

7. The method of claim 6, additionally comprising:
obtaining information about the workstation; and
using the information to select the print driver from a library.

8. The method of claim 6, additionally comprising:
using a MAC address to assist in authenticating print jobs from the workstation.

9. The method of claim 6, additionally comprising:
using a webpage to present a questionnaire to a user of the workstation.

10. A method of authenticating a print job, comprising:
downloading and installing a print driver on a workstation;
downloading an authentication code to the workstation;
sending a print job, containing the authentication code, from the workstation to a print server;
verifying validity of the authentication code; and
sending the print job to a printer.

11. The method of claim 10, additionally comprising:
gathering information from the workstation to indicate a preferred print driver to be sent to the workstation.

12. The method of claim 10, additionally comprising:
using a MAC address to aid in authenticating that the print job was sent from an authorized location.

13. A processor-readable medium having processor-executable instructions thereon which, when executed by a computer, cause the computer to:
download and install a print driver on a workstation;
download and install an authentication code on the workstation;
send a print job, containing the authentication code, from the workstation to a print server;
verify validity of the authentication code using an authentication module on the print server; and
send the print job from the print server to a printer.

14. The processor-readable media of claim 13, having further instructions which cause the processors to:
gather information from the workstation to indicate a preferred print driver to be sent to the workstation.

15. The processor-readable media of claim 13, having further instructions which cause the processors to:
obtain information about the workstation; and
use the information to select the print driver from a library.

16. The processor-readable media of claim 13, having further instructions which cause the processors to:
use a MAC address aid in recognizing a location of the workstation.

17. The processor-readable media of claim 13, having further instructions which cause the processors to:
obtain information about the workstation from fields sent by a browser on the workstation.

18. A print server, comprising:
a printer set-up module to provide a print driver for installation on a workstation; and
an authentication module to supply an authentication code to the workstation, and to review a print job processed by the print driver and sent from the workstation to determine validity of the authentication code attached to the print job.
